(19) United States
(12) Patent Application Publication
(10) Pub. No.: US 2018/0176875 A1
(43) Pub. Date: Jun. 21, 2018

(54) GUARD PERIOD IN A FRAME

(71) Applicant: NOKIA SOLUTIONS AND NETWORKS OY, Espoo (FI)

(72) Inventors: Esa Tapani TIIROLA, Kempele (FI); Eeva LAHETKANGAS, Oulu (FI); Kari Pekka PAJUKOSKI, Oulu (FI)

(21) Appl. No.: 15/737,263

(22) PCT Filed: Jun. 19, 2015
(86) PCT No.: PCT/EP2015/063796

§ 371 Date: Dec. 15, 2017

(51) Int. Cl. H04W 56/00; H04L 27/26

(52) U.S. Cl. CPC H04W 56/0045; H04L 27/2646; H04L 5/0007; H04W 56/003; H04L 27/2666

(57) ABSTRACT

An aspect of the invention is related to an apparatus comprising at least one processor and at least one memory including a computer program code, the at least one memory and the computer program code configured to, with the at least one processor, cause the apparatus at least to: determine a cell for guard period adaptation; define, for the guard period adaptation, at least two guard period portions of the cell with different guard period lengths within a frame the defining being based on at least one of the following: location of at least one network node in the cell and a propagation delay with respect to the at least one network node, and inform the at least one network node on at least one of the at least two guard period portions of the cell for transmission and/or reception.

### FIELD

The invention relates to communications.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

It is predicted that wireless data traffic will grow 10,000 fold within the next 20 years due to ultra-high resolution video streaming, cloud-based work, entertainment and increased use of a variety of wireless devices, such as smartphones, tablets and other new devices, including machine type communications for the programmable world. Thus mobile communications will have a wider range of use cases and related applications including video streaming, augmented reality, different ways of data sharing and various forms of machine type applications, including vehicular safety, different sensors and real-time control. System design flexibility is also needed to support future applications that are not yet fully understood or known.

### SUMMARY

According to an aspect of the present invention, there is provided an apparatus comprising: at least one processor and at least one memory including a computer program code, the at least one memory and the computer program code configured to, with the at least one processor, cause the apparatus at least to: determine a cell for guard period adaptation, define, for the guard period adaptation, at least two guard period portions of the cell with different guard period lengths within a frame the defining being based on at least one of the following: location of at least one network node in the cell and a propagation delay with respect to the at least one network node, and inform the at least one network node on at least one of the at least two guard period portions of the cell for transmission and/or reception.

According to another aspect of the present invention, there is provided a method comprising: determining a cell for guard period adaptation, defining, for the guard period adaptation, at least two guard period portions of the cell with different guard period lengths within a frame the defining being based on at least one of the following: location of at least one network node in the cell and a propagation delay with respect to the at least one network node, and informing the at least one network node on at least one of the at least two guard period portions of the cell for transmission and/or reception.

According to yet another aspect of the present invention, there is provided an apparatus comprising: means for determining a cell for guard period adaptation, means for defining, for the guard period adaptation, at least two guard period portions of the cell with different guard period lengths within a frame the defining being based on at least one of the following: location of at least one network node in the cell and a propagation delay with respect to the at least one network node, and means for informing the at least one network node on at least one of the at least two guard period portions of the cell for transmission and/or reception.

According to yet another aspect of the present invention, there is provided a computer program, comprising program code portions for controlling executing of a process, the process comprising: determining a cell for guard period adaptation, defining, for the guard period adaptation, at least two guard period portions of the cell with different guard period lengths within a frame the defining being based on at least one of the following: location of at least one network node in the cell and a propagation delay with respect to the at least one network node, and informing the at least one network node on at least one of the at least two guard period portions of the cell for transmission and/or reception.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 depicts an example of guard period portions of a cell;

FIG. 4 depicts on example of guard period length variants;

FIG. 5 illustrates examples of apparatuses, and

FIG. 6a-c illustrates examples of frames.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are 5G, the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

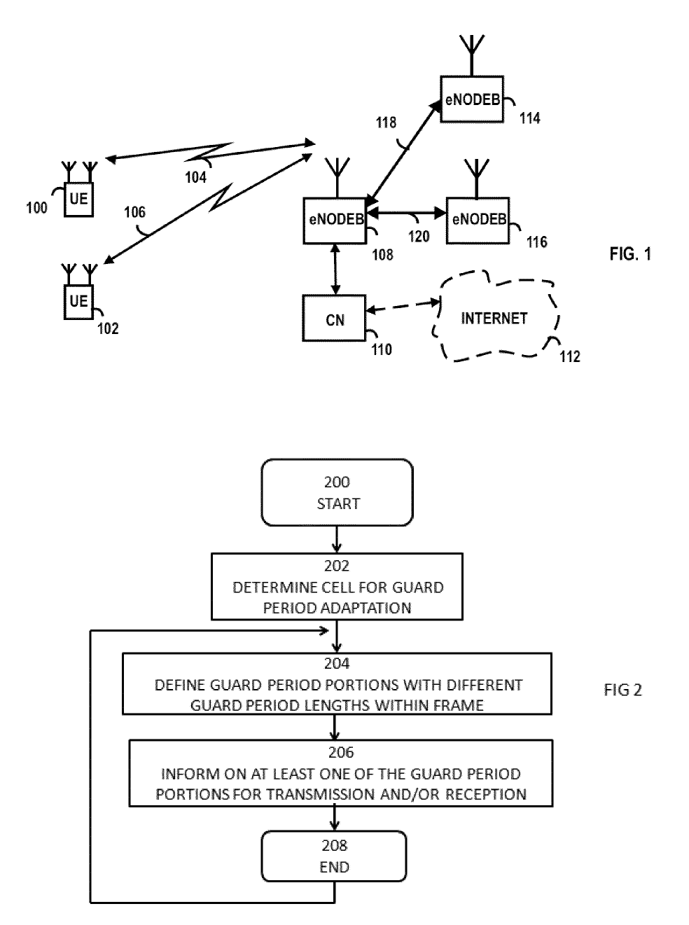

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are Software-Defined Networking (SDN), Big Data, and all-IP, which may change the way networks are being constructed and managed.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of LTE Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the (e)NodeB to the user device is called downlink or forward link.

Two other nodes (eNodeBs) are also provided, namely 114 and 116 which may have communications channels 118 and 120 to eNode B 108. The nodes may belong to the network of a same operator or to the networks of different operators. It should be appreciated that the number of nodes may vary, as well as the number of networks. User devices communicating with nodes 114 and 116 are not shown due to the sake of clarity. The nodes may have connections to other networks, as well.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes or is coupled to transceivers. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The communication system may also comprise a central control entity, or a like, providing facilities for networks of different operators to cooperate for example in spectrum sharing.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

The user device (or in some embodiments a layer 3 relay node or a self-backhauling node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1 may provide any kind of these cells. A cellular radio system may be implemented as a multilayer network including several kinds of cells. Typically, in multilayer networks, one node B provides one kind of a cell or cells, and thus a plurality of (e) Node Bs are required to provide such a network structure.

For fulfilling the need for improving the deployment and performance of communication systems, the concept of “plug-and-play” (e)NodeBs has been introduced. Typically, a network which is able to use “plug-and-play” (e)Node Bs, includes, in addition to Home (e)NodeBs (H(e)nodeBs), a home node B gateway, or HNB-GW (not shown in FIG. 1). A HNB Gateway (HNB-GW), which is typically installed within an operator's network may aggregate traffic from a large number of HNBs back to a core network.

One of the key design parameters in improving user experience is radio latency. Radio latency usually means the one-way transit time between a packet being available at the Internet Protocol (IP) layer in either a device/RAN edge node or the availability of this packet at the IP layer in a RAN edge node/device. The relevance of latency is often overlooked when focusing on achievable data rates, but with high latency, even the fastest connections cannot provide a good experience for interactive services. In the future, the variety of interactive services will broaden as we see the rise of augmented reality, work and entertainment in the cloud, automated cars and remotely controlled robots, for example. All of these applications require low latency. One way to reduce radio interface latency is by using dynamic time division duplex (TDD) with a short frame duration and an adaptive frame structure. Dynamic TDD may involve different cells in the network employing different uplink-downlink TDD splits based on the traffic load for their cell. It is expected that the main mode of operation for 5G ultra dense networks operating above 6 GHz frequency bands will be dynamic TDD. Dynamic TDD is attractive for use in 5G small cells as it is able to assign the full spectrum allocation to whichever link direction needs it the most.

In the following, embodiments suitable for providing a TDD arrangement with adaptability to an UE (user device) and/or link type and/or cell size are disclosed in further detail. The embodiment may be carried out by a network element, such as a base station or (e)NodeB, node, host or server providing or controlling a radio cell.

The embodiment starts in block 200.

In block 202, a cell for guard period adaptation is determined. The cell may comprise user devices or relay nodes (in case of self-backhauling, for example) in different locations within the cell. The cell may be macro cell or another cell having variation in propagation delay.

Guard periods are usually used to decrease interference caused by different transmissions. These transmissions may belong to different users (as in TDMA) or to the same user (as in OFDM). In the TDD mode, the same frequency band is used for uplink and downlink transmission, but in different time instants. A (time) guard period (GP) between a transmission direction switching is designed to provide a sufficient off-power of a transmitter for avoiding power leakage in the receiver chain and/or a compensation of propagation delay and delay spread towards receiving devices before they switch to transmission mode.

In block 204, at least two guard period portions of the cell with different guard period lengths within a frame is defined for the guard period adaptation the defining being based on at least one of the following: location of at least one network node in the cell and a propagation delay with respect to the at least one network node.

A network node may be a user device, a relay node or a like.

Each guard period portion may apply a frame structure with a unique guard period (GP) length. The GP length typically increases with distance and/or propagation delay to make it suitable for network nodes in different locations within a cell especially when the cell area is large. For example, a guard period is short, when a network node is near the network element providing the cell, and the guard period is long, when a network node is near cell edge. In an embodiment, the difference between GP lengths of different guard period portions is defined by the orthogonal frequency division multiple access (OFDMA) symbol granularity. The reception timing of UL signal may be adjusted by means of timing advance (timing/time offset). Timing advance is typically a negative offset, at the UE/relay node, between the start of a received downlink subframe and a transmitted uplink subframe. This offset at the UE is necessary to ensure that the downlink and uplink subframes are synchronised at the eNodeB. A Timing/time offset value may be defined separately for each UE/link. A timing/time offset may also be added between frames or inside a frame for timing purposes. An eNB may dynamically adjust to timing offset value to keep the reception timing of each UE/link at desired operation point. Timing offset may be used to define the difference of reception times of uplink transmissions having different GP lengths. The timing offset may be defined by orthogonal frequency division multiple access (OFDMA) symbol granularity, such as to be a multiple of a symbol length.

The number of guard period portions or options may vary according to the mobility of network nodes, location of network nodes, cell area (it may also vary) etc. The guard period portions may be defined dynamically based on mobility information on network nodes or the definition may be checked or carried out periodically.

In one embodiment, GP length configuration may be carried out in a network node specific manner. Thus, network nodes configured with different GP lengths may coexist in a same subframe. The guard period length for each network node may be signaled using a network node identity, such as user device identity.

It is also possible to create timing advance or timing offset groups or use existing ones. In this case, each guard period variant may belong (or operate according) to a different timing advance group. There may be also a timing offset (e.g. one or more OFDMA symbols) between Rx (receiver) timing of different GP variants or lengths. A network element, such as a node or eNB may adjust a timing advance for UEs/links corresponding to different GP length variants or options in such a manner that Rx timing of UL signal is aligned between UEs/links within each GP (length) variant or option. Additionally, a symbol alignment but a fixed offset counted in full (OFDMA) symbols between Rx timing of UL signals between UEs/links corresponding to different GP variants may be provided.

In one embodiment, different guard period variants or lengths may be utilized for different link types, for example, a long guard period for a self-backhauling link and a short one for a regular radio access link. This means that self-backhauling can apply an optimized frame format dynamically without any impact to GP overhead in the access link.

Typically, when a guard period length varies, the length of the part of the frame allocated to uplink or downlink data or control information varies too, since the length of the subframe does not change. Thus, for example, a frame with a short guard period may have an auxiliary data block. This auxiliary data block may be seen as extra control or data symbols. These control or data symbols allow keeping an uplink control portion at a fixed position regardless of the link direction (uplink or downlink) and subframe format (GP length).

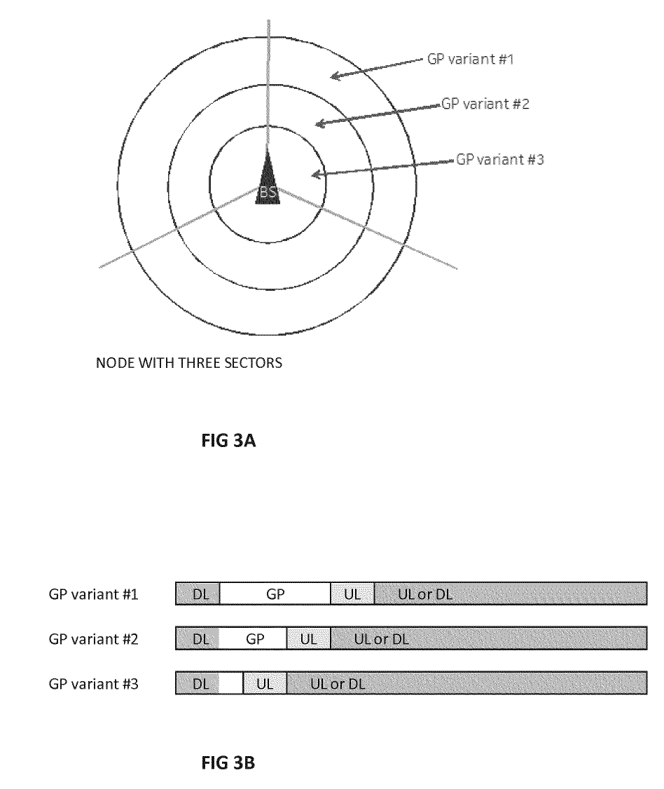

An example of guard period portions of a cell is illustrated in FIGS. 3A and 3B. The example is simplified and is presented only for clarification purposes. It should be understood that the number of guard period portions and the guard period lengths may vary from that shown in FIGS. 3A and 3B. In FIG. 3A, a sectorized cell is shown (cells are typically sectors or sectorized, but not necessarily, the number of sectors or cells may vary, too). Three guard period portions (GP variant #1, GP variant #2 and GP variant #3) are shown. In FIG. 3B, subframe formats each including a guard period which length is adapted to the distance and/or propagation delay are shown. It can be seen how the part of the frame allocated to uplink or downlink data or control information varies according to the length of the guard period.

In block 206, the at least one network node is informed on at least one of the at least two guard period portions of the cell for transmission and/or reception. This may be carried out as a part of normal downlink signaling informing allocated resources or it may be signaled as special information. It's also possible to use higher layer signalling to indicate a user device/relay node about a guard period length and/or frame structure. It's also possible to define multiple GP length/rame structure options via higher layer signalling (either cell specific or user device specific) and to select the actual GP length/frame structure by means of (dynamic) downlink signaling informing allocated resources. Informing may comprise the transmission of information and/or the preparation of such a transmission (e.g. a signaling message).

In one embodiment, a network node may carry out an initial access to a cell on the basis of a default guard period configuration defined for the cell. The default guard period configuration may be the configuration defined for cell edge conditions.

It is possible to define an additional (e.g. small cell optimized) guard period between uplink (UL) and uplink/downlink (UL/DL)-data portions of subframes and configurations. This enables maintaining a symbol alignment between UL/DL data symbols and further enabling UL/DL symmetric demodulation reference signal (DMRS) design.

In one embodiment, the time offset and/or the guard period lengths are determined in such a manner that transmission and reception take place at different periods of time. For example, a network element may determine the guard period length and/or time offset in its transmission frame and the guard period length and/or time offset in network node's (such as user device's) transmission frame to “match” to each other in such a way that the network element may operate in a half-duplex mode that is to say it is able to transmit and receive in turns, not simultaneously.

In one embodiment, a network element may configure a frame structure with at least one downlink part, at least one guard period and at least one uplink part per each subframe structure with different guard period length. The guard periods in these frame structures have different lengths (shorter or longer) and/or timing offsets. A user device (network node) may be informed on one of these frame structures for radio communication either separately or in the context of informing the guard period portion(s). Or, as another option, all the frame structures may be communicated (by broadcasting, for example) and the user device (network node) chooses the correct one based on the guard period portion(s) informed, in which case the connection between the frame structure and the guard period portion may also be informed.

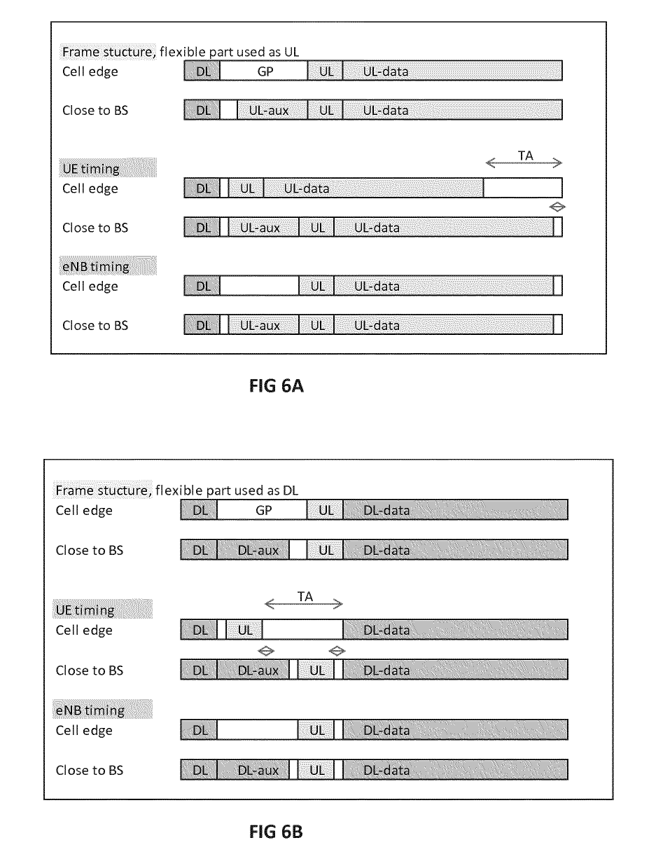

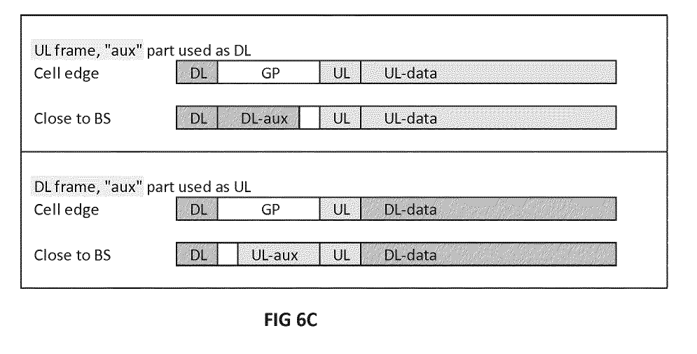

FIGS. 6a, 6b and 6c depict some examples of subframes. In the Figures, DL means a downlink control block, GP means a guard period, UL means an uplink control block, UL-data means an uplink data block and DL-data means a downlink data block. Blocks without a name are guard periods.

FIG. 6a shows an exemplifying uplink subframe, wherein when a guard period (GP) is short, the “free space” may be used for an auxiliary uplink data block (UL-aux) and/or the timing is aligned by using a time offset (TA).

FIG. 6b shows an exemplifying downlink subframe, wherein when a guard period (GP) is short, the “free space” may be used for an auxiliary downlink data block (DL-aux) and/or the timing is aligned by using a time offset (TA).

FIG. 6c shows an exemplifying uplink frame, wherein the “free space” is used for downlink data and an exemplifying downlink frame, wherein the “free space” is used for uplink data. A time offset may also be used in these cases.

The embodiment ends in block 208. The embodiment is repeatable in many ways. An example is shown by arrow 210 in FIG. 2. It should be understood that the embodiment may be repeated one or more times with a constant or variable pause between separate rounds. For example, the determination of a cell may be carried out less frequently than the adaptation of guard period portions or lengths (options, variations) inside the cell. It should also be appreciated that the guard period length or a guard period portion may be redetermined without a need to change the guard period portion area or the number of guard period portions. The redetermination may be carried out by using the time/timing offset presented above or adapting the guard period length itself. The redetermination of the guard period length may also be temporary.

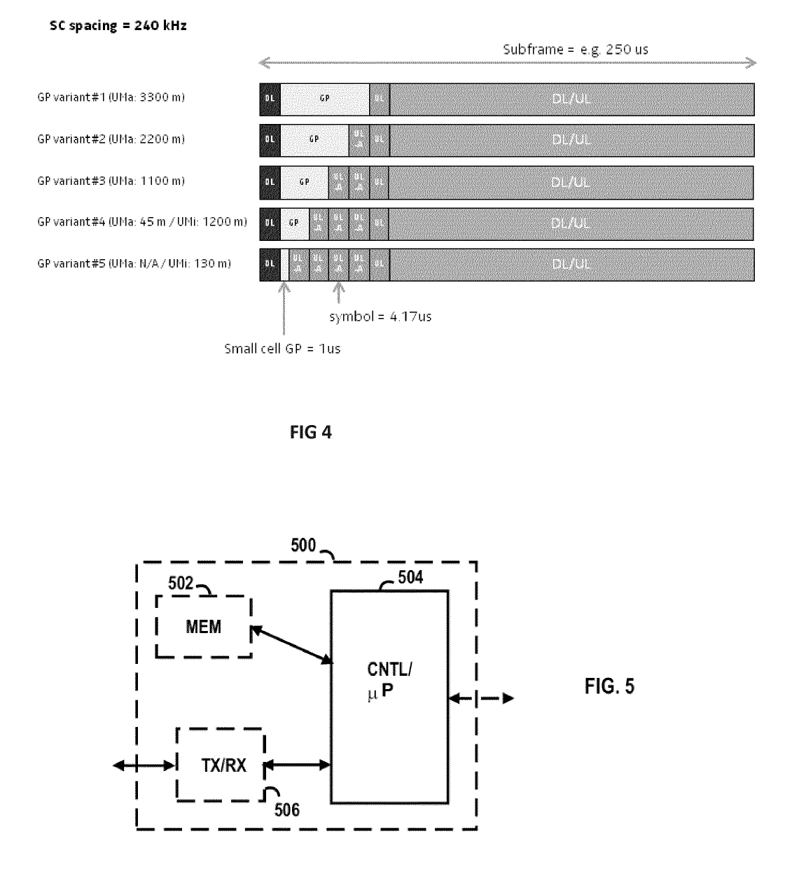

In the following, a more detailed example of guard period length variations are explained by means of FIG. 4. The example should only be taken as a clarifying not a limiting example. The subframe of the example is suitable for a cmWave frequency range. Subcarrier spacing is 240 kHz and an auxiliary data block provided when the guard period is short is allocated for uplink usage, but it may as well be used for downlink traffic. The imaginary scenario supports small cell environment with 130 m inter-site distance (ISD) in urban micro environment up to >3 km ISD in urban macro environment. The numerology is only an example and it can vary case by case.

The steps/points, signaling messages and related functions described above in FIG. 2 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, broadcasting, signalling transmitting and/or receiving may herein mean preparing a data conveyance, broadcast, transmission and/or reception, preparing a message to be conveyed, broadcasted, signalled, transmitted and/or received, or physical transmission and/or reception itself, etc. on a case by case basis. The same principle may be applied to terms transmission and reception as well.

An embodiment provides an apparatus which may be a network element, node, host or server or any other suitable apparatus capable to carry out processes described above in relation to FIG. 2. FIG. 5 illustrates a simplified block diagram of an example of such an apparatus.

It should be appreciated that an apparatus may include or otherwise be in communication with a control unit, one or more processors or other entities capable of carrying out operations according to the embodiments described by means of FIG. 2. It should be understood that each block of the flowchart of FIG. 2 and any combination thereof may be implemented by various means or their combinations, such as hardware, software, firmware, one or more processors and/or circuitry.

As an example of an apparatus according to an embodiment, it is shown apparatus 500, such as a node (eNodeB, for example), including facilities in control unit 504 (including one or more processors, for example) to carry out functions of embodiments according to FIG. 2. The facilities may be software, hardware or combinations thereof as described in further detail below.

In FIG. 5, block 506 includes parts/units/modules needed for reception and transmission, usually called a radio front end, RF-parts, radio parts, remote radio head, etc. The parts/units/modules needed for reception and transmission may be comprised in the apparatus or they may be located outside the apparatus the apparatus being operationally coupled to them. The apparatus may also include or be coupled to one or more internal or external memory units.

Another example of apparatus 500 may include at least one processor 504 and at least one memory 502 including a computer program code, the at least one memory and the computer program code configured to, with the at least one processor, cause the apparatus at least to determine a cell for guard period adaptation, define, for the guard period adaptation, at least two guard period portions of the cell with different guard period lengths within a frame the defining being based on at least one of the following: location of at least one network node in the cell and a propagation delay with respect to the at least one network node, and inform the at least one network node on at least one of the at least two guard period portions of the cell for transmission and/or reception.

It should be understood that the apparatus may include or be coupled to other units or modules etc., such as radio parts or radio heads, used in or for transmission and/or reception. This is depicted in FIG. 5 as optional block 506.

Yet another example of an apparatus comprises means (504) for determining a cell for guard period adaptation, means (504) for defining, for the guard period adaptation, at least two guard period portions of the cell with different guard period lengths within a frame the defining being based on at least one of the following: location of at least one network node in the cell and a propagation delay with respect to the at least one network node, and means 504, 506) for informing the at least one network node on at least one of the at least two guard period portions of the cell for transmission and/or reception.

It should be understood that the apparatus may include or be coupled to other units or modules etc., such as radio parts or radio heads, used in or for transmission and/or reception. This is depicted in FIG. 5 as optional block 506.

Although the apparatuses have been depicted as one entity in FIG. 5, different modules and memory may be implemented in one or more physical or logical entities.

An apparatus may in general include at least one processor, controller or a unit or module designed for carrying out functions of embodiments operationally coupled to at least one memory unit (or service) and to typically various interfaces. Further, the memory units may include volatile and/or non-volatile memory. The memory unit may store computer program code and/or operating systems, information, data, content or the like for the processor to perform operations according to embodiments described above in relation to FIG. 2. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. The data storage medium may be a non-transitory medium. The computer program or computer program product may also be loaded to the apparatus. A computer program product may comprise one or more computer-executable components which, when the program is run, for example by one or more processors possibly also utilizing an internal or external memory, are configured to carry out any of the embodiments or combinations thereof described above by means of FIGS. 2, 3, 4A and 4B. The one or more computer-executable components may be at least one software code or portions thereof. Computer programs may be coded by a programming language or a low-level programming language.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
determine a cell for guard period adaptation;
define, for the guard period adaptation, at least two guard period portions of the cell with different guard period lengths within a frame the defining being based on at least one of the following: location of at least one network node in the cell and a propagation delay with respect to the at least one network node, and
inform the at least one network node on at least one of the at least two guard period portions of the cell for transmission and/or reception.

2. The apparatus of claim 1, further comprising causing the apparatus to:
add an auxiliary uplink and/or downlink data block for keeping an uplink control portion at a fixed position regardless of the guard period length and/or a link direction.

3. The apparatus of claim 1, further comprising causing the apparatus to:
define a timing offset between frames and/or inside the frame for uplink reception timing purposes.

4. The apparatus of claim 3, wherein the timing offset is defined by orthogonal frequency division multiple access (OFDMA) symbol granularity.

5. The apparatus of claim 1, further comprising causing the apparatus to: determine the time offset and/or the guard period lengths in such a manner that transmission and reception take place at different periods of time.

6. The apparatus of claim 1, further comprising causing the apparatus to:
use one of the different guard period lengths for a self-backhauling link and another one for a regular radio access link.

7. The apparatus of claim 1, wherein the difference with the different guard period lengths is defined by orthogonal frequency division multiple access (OFDMA) symbol granularity.

8. The apparatus of claim 1, further comprising causing the apparatus to:
determine at least two frame structures, wherein each of the at least two frame structures has at least one downlink part, at least one guard period and at least one uplink part;
configure the at least two frame structures in such a manner, that at least one of the two frame structures has a first guard period length and at least one other of the two frame structures has a second guard period length, wherein the first guard period length and the second guard period length are the different guard period lengths, and
inform the at least one network node on the at least one of the at least two frame structures and/or on the at least one other of the two frame structures for transmission and/or reception.

9. The apparatus of claim 1, further comprising a radio interface entity providing the apparatus with capability for radio communications.

10. A method comprising:
determining a cell for guard period adaptation;
defining, for the guard period adaptation, at least two guard period portions of the cell with different guard period lengths within a frame the defining being based on at least one of the following: location of at least one network node in the cell and a propagation delay with respect to the at least one network node, and
informing the at least one network node on at least one of the at least two guard period portions of the cell for transmission and/or reception.

11. The method of claim 10, further comprising:
adding an auxiliary uplink and/or downlink data block for keeping an uplink control portion at a fixed position regardless of the guard period length and/or a link direction.

12. The method of claim 10 or 11, further comprising:
defining a timing offset between frames and/or inside the frame for uplink reception timing purposes.

13. The method of claim 12, wherein the timing offset is defined by orthogonal frequency division multiple access (OFDMA) symbol granularity.

14. The method of claim 10, further comprising: determining the time offset and/or the guard period lengths in such a manner that transmission and reception take place at different periods of time.

15. The method of claim 10, further comprising:
using one of the different guard period lengths for a self-backhauling link and another one for a regular radio access link.

16. The method of claim 10, wherein the difference with the different guard period lengths is defined by orthogonal frequency division multiple access (OFDMA) symbol granularity.

17. The method of claim 10, further comprising:
determining at least two frame structures, wherein each of the at least two frame structures has at least one downlink part, at least one guard period and at least one uplink part;
configuring the at least two frame structures in such a manner, that at least one of the two frame structures has a first guard period length and at least one other of the two frame structures has a second guard period length, wherein the first guard period length and the second guard period length are the different guard period lengths, and
informing the at least one network node on the at least one of the at least two frame structures and/or on the at least one other of the two frame structures for transmission and/or reception.

18. An apparatus comprising means for carrying out the method of claim 10.

19. (canceled)

20. A non-transitory computer-readable storage medium comprising instructions stored thereon that, when executed by at least one processor, are configured to cause a computing system to perform a process comprising:
determining a cell for guard period adaptation;
defining, for the guard period adaptation, at least two guard period portions of the cell with different guard period lengths within a frame the defining being based on at least one of the following: location of at least one network node in the cell and a propagation delay with respect to the at least one network node, and
informing the at least one network node on at least one of the at least two guard period portions of the cell for transmission and/or reception.
